(19) United States
(12) Patent Application Publication
(10) Pub. No.: US 2026/0359171 A1
(43) Pub. Date: Nov. 12, 2026

(54) METHOD FOR BACKING UP METADATA OF FILE ON HDD, AND METADATA BACKUP SERVER

(71) Applicant: CLOUD INTELLIGENCE ASSETS HOLDING (SINGAPORE) PRIVATE LIMITED, Singapore (SG)

(72) Inventor: Shuqi ZHAO, Beijing (CN)

(21) Appl. No.: 19/477,052

(22) PCT Filed: May 8, 2024
(86) PCT No.: PCT/CN2024/091765

§ 371 Date: Oct. 20, 2025

(30) Foreign Application Priority Data
May 8, 2023 (CN) 202310530686.4

(51) Int. Cl. G06F 11/1446

(52) U.S. Cl. CPC G06F 11/1464; G06F 11/1451; G06F 2201/80

(57) ABSTRACT

The present disclosure discloses a method for backing up metadata of a file on an HDD and a metadata backup server, and relates to the field of cloud computing technologies. The method includes: acquiring directory information of data written on the HDD by a data service; monitoring a written file closing event of the directory information, and acquiring closed file information returned according to the written file closing event; and determining a closed file according to the closed file information, acquiring metadata of the closed file, and backing up the metadata to a metadata backup warehouse. In the present disclosure, the metadata of the closed file can be acquired as much as possible when the metadata is still in kernel memory, and backup of the metadata to the metadata backup warehouse can be achieved while an additional disk I/O operation is avoided.

The present disclosure is a National Stage of International Application No. PCT/CN2024/091765, filed on May 8, 2024, which claims priority to Chinese Patent Application No. 202310530686.4, filed with the China National Intellectual Property Administration on May 8, 2023 and entitled “METHOD FOR BACKING UP METADATA OF FILE ON HDD, AND METADATA BACKUP SERVER”, these applications are incorporated herein by reference in their entireties.

### TECHNICAL FIELD

The present disclosure relates to the field of cloud computing, and specifically, to a method for backing up metadata of a file on an HDD, and a metadata backup server.

### BACKGROUND

This section is intended to provide a background or context for embodiments of the present disclosure stated in the claims. The descriptions herein are not recognized as the prior art by virtue of being included in this section.

For a storage system, no data loss and no errors are an eternal pursuit. However, in a production system, requirements for retrieving data after data deletion are still faced due to various reasons, for example, unintentional file deletion caused by storage-system software problems, unintentional file deletion or file system corruption caused by operations and maintenance operations, or unintentional file deletion caused by user misoperations. To hold a bottom line of zero data loss and satisfy user service requirements, the storage system needs to recover the unintentionally deleted files. For an SSD (Solid State Disk or Solid State Drive) flash disk, full-disk scanning is a final guarantee. However, for an HDD (Hard Disk Drive, mechanical hard disk) magnetic drive with increasingly larger space but little change in input/output (I/O) capability, the time for a full-disk scan needs to be measured in weeks. This severely affects timeliness of recovering a storage service, and may bring a devastating blow to information. To accelerate data recovery, it is especially important to back up metadata of files on HDDs. However, an existing backup solution needs to consume a large portion of disk I/O capability, and this is usually unacceptable for HDDs with limited performance.

### SUMMARY

Embodiments of the present disclosure provide a method for backing up metadata of a file on an HDD and a metadata backup server, so that the backup of the metadata of the file on the HDD can be completed while an additional disk I/O operation is avoided.

According to an aspect of the present disclosure, a method for backing up metadata of a file on an HDD is further provided, including: acquiring directory information of data written on the HDD by a data service; monitoring a written file closing event of the directory information, and acquiring closed file information returned according to the written file closing event; and determining a closed file according to the closed file information, acquiring metadata of the closed file, and backing up the metadata to a metadata backup warehouse.

According to another aspect of the present disclosure, a metadata backup server is further provided, including: an acquisition module, an event module, and a backup module; the acquisition module is configured to acquire directory information of data written on an HDD by a data service; the event module is configured to monitor a written file closing event of the directory information, and acquire closed file information returned according to the written file closing event; and the backup module is configured to determine a closed file according to the closed file information, acquire metadata of the closed file, and back up the metadata to a metadata backup warehouse.

According to another aspect of the present disclosure, a storage system is further provided, which includes the foregoing metadata backup server.

According to another aspect of the present disclosure, an electronic device is further provided, which includes: a processor and a storage storing a program, where the program includes instructions, and the instructions, when executed by the processor, cause the processor to perform the foregoing method.

According to another aspect of the present disclosure, a non-transitory computer-readable storage medium storing computer instructions is further provided, where the computer instructions are used for causing a computer to perform steps of the foregoing method.

According to another aspect of the present disclosure, a computer program product is further provided, where the computer program product includes a computer program, and the computer program, when executed by a processor, implements steps of the foregoing method.

Beneficial effects of the embodiments of the present disclosure are as follows.

In the embodiments of the present disclosure, the directory information of the data written on the HDD by the data service is acquired; the written file closing event of the directory information is monitored, and the closed file information returned according to the written file closing event is acquired; and the closed file is determined according to the closed file information, the metadata of the closed file is acquired, and the metadata is backed up to the metadata backup warehouse. In the present disclosure, the directory information of the data written on the HDD by the data service is monitored in an operating system. When it is detected that the written file closing event occurs, the closed file information returned according to the written file closing event is acquired. The closed file is determined according to the closed file information. In this way, the metadata of the closed file is acquired when the metadata is still in kernel memory as much as possible, and backup of the metadata to the metadata backup warehouse is implemented while the additional disk I/O operation is avoided.

Details of one or more embodiments of the present disclosure are provided in the following accompanying drawings and descriptions, so that other features, objectives, and advantages of the present disclosure are more concise and understandable.

### BRIEF DESCRIPTION OF THE DRAWINGS

To describe the technical solutions in embodiments of the present disclosure or in the related art more clearly, the following briefly describes the accompanying drawings needed for describing the embodiments or the prior art. It is clear that, the accompanying drawings in the following descriptions are merely some embodiments of the present disclosure, and a person of ordinary skill in the art may further obtain other embodiments according to the accompanying drawings without creative efforts.

FIG. 1 is a flowchart of a method for backing up metadata of a file on an HDD according to an embodiment of the present disclosure;

FIG. 2 is a schematic flowchart of normal backup and corrective backup according to an embodiment of the present disclosure; and

FIG. 3 is a structural block diagram of an exemplary electronic device that can be used to implement an embodiment of the present disclosure.

### DETAILED DESCRIPTION

The following describes embodiments of the present disclosure in more detail with reference to the accompanying drawings. Although some embodiments of the present disclosure are shown in the accompanying drawings, it should be understood that the present disclosure may be implemented in various forms and should not be construed as being limited to the embodiments described herein. On the contrary, these embodiments are provided for a more thorough and complete understanding of the present disclosure. It should be understood that the accompanying drawings and the embodiments of the present disclosure are merely used as examples, and are not intended to limit the protection scope of the present disclosure.

In an existing solution 1 of backing up metadata of a file on an HDD, backup of the metadata is implemented through full/incremental scanning of the file. In this solution, files stored on the disk are scanned periodically, then metadata information of the files is acquired by calling stat file by file, extent information of the files is acquired by using a fiemap interface, and then the metadata/extent information of each file is persisted to complete full backup of file metadata or incremental backup of modified file metadata since the last time of backup. However, in this method, a file traversal order is decoupled from a disk storage manner, and therefore, a large quantity of random read operations are needed. Consequently, excessive disk performance needs to be consumed, and normal services are affected.

An existing solution 2 of backing up metadata of a file on an HDD is a file-system-specific metadata backup solution. A first manner for implementing the solution 2 is an inode table (a data structure in a file system, used for storing metadata information of a file and a directory, including a size, creation time, modification time, access permission, and the like of the file) backup manner: For a conventional file system design, metadata is usually stored in a relatively contiguous area. To reduce a quantity of disk I/Os for metadata backup, the metadata backup may be completed by parsing content of a metadata area of the file system. For example, storage space of each inode of ext3 occupies 128 bytes, and space of each inode of ext4 occupies 256 bytes. Metadata of 512 ext3 partition files or metadata of 256 ext4 partition files may be acquired through one I/O operation of 64K. Therefore, in comparison with the solution 1, the quantity of disk I/Os is reduced by an order of magnitude.

Because an upper limit of I/OPS (Input/Output Operations Per Second) of HDD disks is low, and stored data is generally discrete, the solution 1 and the first manner of the solution 2 involve frequent random reads and writes, and the metadata backup manner is highly unfriendly to HDDs. A second manner for implementing the solution 2 is a journal area backup manner, where backup is completed by parsing a journal area of the file system. Because the journal area contains backups of modified metadata, metadata backup is completed by parsing a file-system-specific journal format. However, the journal area usually reserves a plurality of modifications of a same file. In addition, storage efficiency is low, a large amount of space is wasted, and a problem that reserved space of a journal may be small is usually faced. Therefore, a high requirement is imposed on the time window for a backup service to read the journal. In addition, journal formats of different file systems may be different, increasing complexity of solution adaptation.

In conventional solutions in which files are scanned or a metadata area or a journal area of a file system is backed up, it is inevitable to read data on an HDD disk, thereby consuming disk I/O capability and further affecting service performance. To reduce disk I/O operations, metadata backup may be completed by enhancing a kernel. For example, a kernel function is enhanced by using solutions such as a kernel module or a BPF (Berkeley Packet Filter, a highly efficient network data packet processing technology). After modification of metadata of a file is found in a kernel, metadata of the modified file is persisted, thereby completing backup. However, this solution needs modification in a kernel mode, and therefore has a very high requirement on development. A system crash may be caused when a BUG is introduced inadvertently. In addition, an uncontrollable adaptation risk may also be introduced with a change and an iteration of a kernel version.

Based on the foregoing background, the present disclosure currently provides a method for backing up metadata of a file on an HDD and a metadata backup server. In the method, when metadata written to the file is still in memory, metadata information, extent information, and the like of the file are acquired to complete data backup. Finally, disk overheads of metadata backup of a file system are close to zero.

First, related terms are described as follows.
File system: It is a method and a data structure used by an operating system for files on a storage device or a partition, that is, a method for organizing files on a storage device.
ext4 file system: It is a fourth-generation extended file system (Fourth extended filesystem, ext4), a log file system in a Linux system, and a subsequent version of an ext3 file system.
Metadata: It is also referred to as intermediate data and relay data, is data for describing data, mainly describes information about attributes of the data, and is used to support functions such as indicating a storage location, historical data, resource searching, and file logging.
extent: It is a data structure in a file system, and is used to manage storage and retrieval of files on a disk.
fiemap (a system call of a Linux file system): Extents are used in a large quantity of modern file systems to replace blocks to manage a disk. An extent is some consecutive blocks, and one extent is defined by a starting block plus a length. fiemap is a method for acquiring extent information about file storage in a user mode.
Backup: It is a foundation of disaster recovery, and refers to a process of copying all or some data sets from a hard disk or an array of an application host to another storage medium, to prevent data loss caused by a system misoperation or a system failure.
stat: It is a Unix/Linux system call, and is used to acquire metadata information of a file, including information such as a type, a size, permission, creation time, modification time, and access time of the file. The metadata information of the file may be acquired by calling a stat function, and may be stored in a structure.
inode: It is a data structure in a file system, and is used to manage metadata information of files and directories. Each file or directory has one corresponding inode, and the inode includes information such as an attribute, permission, a size, creation time, modification time, and access time of the file or the directory, but does not include actual data of the file.
journal: It is a journaling mechanism of a file system, and is used to record operations and status changes of the file system. A journal may record metadata information of the file system, including operations such as creating, modifying, deleting, and moving of a file, and the status changes of the file system, such as operations like mounting, unmounting, and recovery of the file system.
inotify: It is a file system watching mechanism provided by a Linux kernel, can watch files and directories in a file system, and can notify an application in time when a file or a directory changes.

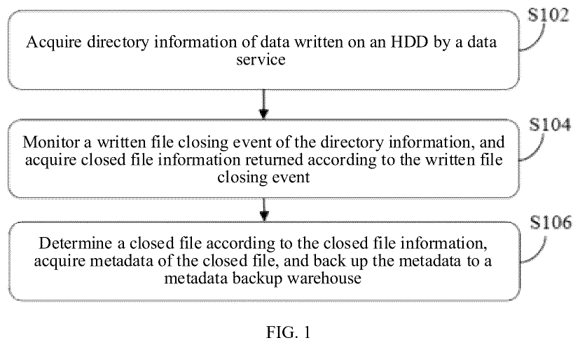

In this embodiment, a method for backing up metadata of a file on an HDD is provided. FIG. 1 is a flowchart of a method for backing up metadata of a file on an HDD according to an embodiment of the present disclosure. The following describes steps of the method involved in FIG. 1.

Step S102: Acquire directory information of data written on the HDD by a data service.

In this step, the data service is responsible for data writing operations. For example, data of various sources that needs to be stored is written into a certain file in a certain directory on the HDD. The directory information is directories in which written files are located. Different file information may belong to a same directory or different directories.

It should be noted that, HDD disks are one of main forms of computer storage, and they are usually used in desktop computers, notebook computers, servers, and other devices.

In this step, after backup of the metadata of the file on the HDD is started, the directory information of the data written by the data service is acquired to monitor the status of the written file in the directory information.

Step S104: Monitor a written file closing event of the directory information, and acquire closed file information returned according to the written file closing event.

In this step, the written file closing event is used to represent that writing or modification to the written file this time has been completed, and the written file is closed. A status of each written file corresponding to the directory information is monitored. When the written file closing event is detected, an operating system returns, according to the written file closing event, description information and identification information related to a closed file, that is, the closed file information. The closed file information returned according to the written file closing event is acquired.

It should be noted that, the written file closing event refers to an operation of closing the file after writing of the file is completed. The operation of closing the file may include the following several aspects: flushing a buffer, releasing a file resource, and ensuring data integrity. The operation of closing the file may ensure persistent storage of data and release of the file resource.

It should be further noted that, the description information related to the closed file may include modified content information of the closed file. The identification information related to the closed file may be used to identify and find the closed file.

In this step, when the written file closing event of the directory information is detected, in this case, although the file is closed, the metadata is still in memory of the operating system. Therefore, the closed file information is acquired to facilitate subsequent acquisition of the metadata based on the file information. Querying the metadata immediately at a closing time point does not generate additional disk I/O.

Step S106: Determine a closed file according to the closed file information, acquire metadata of the closed file, and back up the metadata to a metadata backup warehouse.

In this step, after the closed file information is obtained, the written file that is closed, that is, the closed file, can be determined. When the metadata of the closed file is still in the memory, the metadata of the closed file may be acquired in real time by using a standard operating system interface, thereby completing data backup.

It should be noted that, the metadata of the file refers to data that describes information such as an attribute, a feature, a structure, a format, a source, and quality of the file. Common file metadata includes: a file name, which is a name of a file, and is used to identify the file; a file type, which is a type of the file, like a text file, an image file, an audio file, and a video file; a file size, which is a size of the file, and is represented in units such as byte, kilobyte, and megabyte; creation time and modification time, which are creation time and final modification time of the file; a file path, which is a path of the file in a file system, and is used to identify a location of the file; file permission, which is access permission of the file, including reading, writing, executing and other permission; a file format, which is a format of the file, like a coding format of the text file and a compression format of the image file; a file version, which is a version number of the file, and is used to identify different versions of the file; and a file digest, which is digest information of the file, such as a hash value and a digital signature of the file.

It should be further noted that, the metadata backup warehouse may be a local disk, a network storage device, or a cloud storage service. A specifically used metadata backup warehouse may be selected according to an actual requirement. This is not specifically limited in the embodiments of the present disclosure. System metadata is backed up to the metadata backup warehouse to facilitate recovery when a system fault or a data loss occurs.

In the embodiments of the present disclosure, the directory information of the data written on the HDD by the data service is acquired; the written file closing event of the directory information is monitored, and the closed file information returned according to the written file closing event is acquired; and the closed file is determined according to the closed file information, the metadata of the closed file is acquired, and the metadata is backed up to the metadata backup warehouse. In the present disclosure, the directory information of the data written on the HDD by the data service is monitored in the operating system. When it is detected that the written file closing event occurs, the closed file information returned according to the written file closing event is acquired and the closed file is determined according to the closed file information. In this way, the metadata of the closed file is acquired when the metadata is still in kernel memory as much as possible, and backup of the metadata to the metadata backup warehouse is implemented while the additional disk I/O operation is avoided.

In a possible implementation, monitoring the written file closing event of the directory information and acquiring the closed file information according to the written file closing event may be performed in accordance with the following steps: monitoring the written file closing event of the directory information by using an inotify component, and acquiring the closed file information returned by the inotify component according to the written file closing event, where the closed file information includes a watch descriptor and a file name.

In embodiments of the present disclosure, inotify can help an application watch changes of the file system in real time, thereby improving efficiency and reliability of the application. The written file closing event of the directory information is monitored by using the inotify component. When the written file closing event is detected, the closed file information returned by the inotify component according to the written file closing event can be acquired in time.

The closed file information includes a watch descriptor and a file name. The watch descriptor (WD) is a concept in an inotify mechanism, and represents a watched file or directory. When the inotify mechanism is used, the application may using an inotify_init( ) function to create an inotify instance, using an inotify_add_watch( ) function to add a watched directory and return a watch descriptor representing the directory. The watch descriptor and the file name may be used to identify a complete path of the closed file and uniquely locate a modified file.

It should be noted that, inotify may be used to watch the file system, and inotify may watch files and directories in the file system, including operations such as creating, modifying, deleting, and moving of files. When a file or a directory changes, inotify notifies the application in time. Real-time notification: inotify can notify the application of the change of the file system in real time, avoiding overheads and delays of polling the file system. Precise watching: inotify can precisely watch files and directories in the file system, and may specify a file type, a directory level, a file name, and the like for watching. Wide application scenarios: inotify may be applied to a large quantity of scenarios, such as file synchronization, log watching, and security auditing.

In a possible implementation, determining the closed file according to the closed file information may be performed in accordance with the following steps: generating a closed file path according to the watch descriptor and the file name; and determining the closed file according to the closed file path.

In embodiments of the present disclosure, the closed file path may be obtained by concatenating the watch descriptor with the file name, and the closed file path may be used to find the closed file.

In this step, the closed file may be obtained based on the closed file path to provide support for acquiring the metadata based on the closed file.

In a possible implementation, acquiring the metadata of the closed file may be performed in accordance with the following step: acquiring the metadata of the closed file by using a fiemap interface and/or a stat system call.

In embodiments of the present disclosure, both the fiemap interface and stat may be used to acquire the metadata information of the file system, but use scenarios of the fiemap interface and stat are slightly different.

The fiemap interface is mainly used to acquire physical location information of a file on a disk, and may be used to implement operations such as file defragmentation and file compression. fiemap may acquire location information of all physical blocks of a file, including a hole block in a sparse file. Use of fiemap requires support from the file system.

The stat system call is mainly used to acquire basic attribute information of a file, such as a size, creation time, modification time, and access time of the file. stat may acquire an inode number of a file, which may be used to determine whether two files are a same file. Use of stat does not need root privilege, and is applicable to a common user.

It can be known from the above that if the physical location information of the file needs to be acquired, the fiemap interface may be used; and if the basic attribute information of the file needs to be acquired, the stat call may be used, or the two manners may be used to acquire the metadata of the closed file according to an actual requirement. A specific manner for acquiring the metadata may be determined according to the actual requirement. This is not specifically limited in the embodiments of the present disclosure.

Considering that a conventional backup path relies on that a backup service can sense modifications of all files and normally persist metadata of these modified files, in actual operations, however, an event monitored by inotify may be lost, and a metadata backup service may suddenly be killed or exceptionally exited at a certain instant, resulting in that the metadata of the modified files is not normally backed up in this period. In this case, a separate corrective backup channel is needed to check for omissions. Therefore, in a possible implementation, after the metadata is backed up, the following steps may be further performed: acquiring first metadata of a first file managed by the data service, where the first metadata includes one or more of file name data, creation instant data, Inode data, or file length data; loading second metadata in the metadata backup warehouse; and comparing the first metadata with the second metadata, determining incremental file list information according to a comparison result, acquiring incremental metadata according to the incremental file list information, and backing up the incremental metadata.

In embodiments of the present disclosure, all files being managed by the data service are taken as the first file, and metadata of the first file in the data service is taken as the first metadata. The first metadata includes a plurality of types of metadata, and one or more of the file name data, the creation instant data, the Inode data, or the file length data may be acquired. All the metadata in the metadata backup warehouse is taken as the second metadata.

It should be noted that, the foregoing two steps of acquiring the first metadata of the first file and loading the second metadata in the metadata backup warehouse are two independent steps. The two steps are not performed in any particular order. The two steps may be performed at the same time, or one of the two steps may be selected to be given priority in execution. An order of performing the two steps may be determined according to an actual requirement. This is not specifically limited in the embodiments of the present disclosure.

The first metadata is compared with the second metadata, obtained discrepancy information is used as the comparison result, and the incremental file list information is determined according to the comparison result. The incremental file list information includes a plurality of pieces of file name information. After the incremental file list information is obtained, metadata of a plurality of files that need to be backed up again, i.e., incremental metadata, is acquired according to a method similar to step S106, and then the incremental metadata is supplementarily backed up to the metadata backup warehouse, so that backup metadata in the metadata backup warehouse corresponds to the metadata of the file managed by the data service, thereby avoiding omissions and errors in the backup metadata in the metadata backup warehouse, and reducing impact of various abnormal problem cases on a metadata backup result in a normal backup process.

In this step, the incremental metadata is supplementarily backed up, so that omissions of full backup may be checked and filled, thereby ensuring integrity and accuracy of the metadata.

In a possible implementation, determining the incremental file list information according to the comparison result may be performed in accordance with the following steps: adding file name data corresponding to first target metadata to the incremental file list information if the first metadata includes the first target metadata, and the second metadata does not include the first target metadata; and adding a file name of second target metadata in the first metadata to the incremental file list information if the second target metadata in the first metadata is different from the second target metadata in the second metadata in any one or more of file name data, creation instant data, Inode data, or file length data.

In this step, if first target metadata corresponding to a file exists only in the first metadata and does not exist in the second metadata, it indicates that the file may be omitted during backup or the backup fails. Therefore, file name data of the file corresponding to the first target metadata needs to be added to the incremental file list information to supplementarily back up metadata of the file to the metadata backup warehouse.

It should be noted that, the first target metadata is a subset of the first metadata. The first target metadata is (or is not) a part of data of a subset in the second metadata.

In addition, if the backup process is performed normally, file name data, creation instant data, Inode data, and file length data included in the second target metadata in the first metadata are the same as the data included in the second target metadata in the second metadata. If any one or more of the data are different, a file name of the second target metadata in the first metadata is added to the incremental file list information.

It should be noted that, the second target metadata is metadata of a specific file. If the backup is normal, the second target metadata in the first metadata is the same as that in the second metadata. If the second target metadata in the first metadata is different from that in the second metadata, it proves that there may be an error in the backup process, and the metadata of the file is backed up again in accordance with the content in the first metadata.

In this step, the metadata information such as the file name data, the creation instant data, the Inode data, and the file length data needs relatively little storage space, is contiguously stored in a storage medium, and may also be stored in a high-performance storage device, leading to lower reading overheads. In addition, the first metadata of the first file may also be acquired in a memory mode by using a remote procedure call to the data service, so that no loss is caused to I/O performance of the HDD.

In a possible implementation, acquiring the first metadata of the first file managed by the data service may be performed in accordance with the following step: acquiring, by using the remote procedure call to the data service and/or loading a checkpoint file of the data service, the first metadata of the first file managed by the data service.

In embodiments of the present disclosure, the remote procedure call (RPC) is a computer communication protocol, and is used for remote calling between different computers or different processes of a same computer. In the RPC, a caller (a client) sends a request message to a callee (a server). The request message includes a name and a parameter of a remote procedure to be called. After receiving the request message, the server executes the corresponding remote procedure, and returns a result to the client. After receiving the result, the client continues to execute a local program. The RPC may use different transmission protocols and coding manners.

The checkpoint file is a file used to save a process status, and is usually used to implement recovery and migration of a process. When a process needs to be suspended or migrated, status information of the process, including information such as a memory image, a register status, and a file descriptor of the process, is written into the checkpoint file. The checkpoint file may be read and recovered in another system, so that the process can continue to be executed in a different system.

In this step, the first metadata of the first file being managed by the data service is determined by using the remote procedure call or checkpoint file, or by using the remote procedure call and the checkpoint file, to provide support for acquiring the incremental metadata.

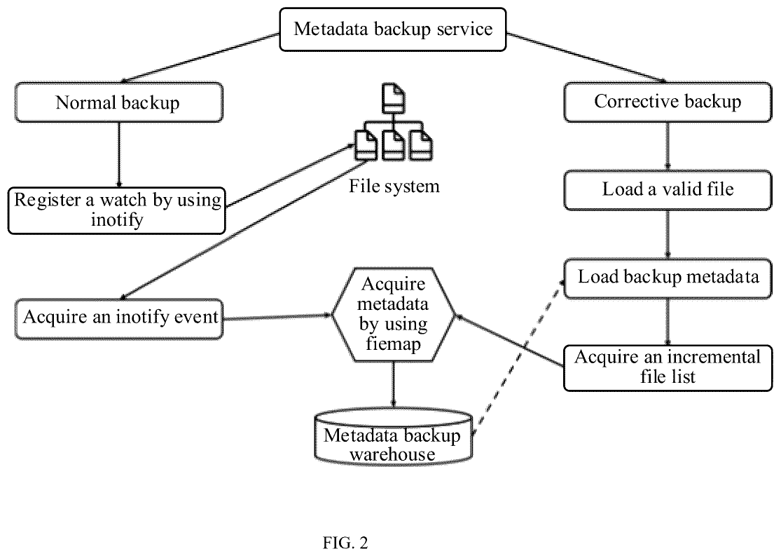

Refer to a schematic flowchart of normal backup and corrective backup shown in FIG. 2. The following describes a possible implementation of the method by using a specific embodiment. To implement a metadata backup service with approximately no additional disk I/O, metadata backup may be completed through two channels: the normal backup, and the corrective backup for checking for and filling omissions.

### 1. Normal Backup

a. After a backup service is started, a directory of data written by a data service is acquired, and a watch for a written file closing event in the directory is registered by using inotify_add_watch.
b. After finding that a file write fd (a file descriptor, which is an integer value used for identifying and accessing a file or other input/output resources in an operating system) in a watched directory is closed, the operating system returns a watch descriptor (wd) of a closed file and a name of the closed file to the metadata backup service by using inotify_event. A metadata backup server may perform concatenation based on the two pieces of information to obtain a complete closed file path.
c. In a file system, basic metadata of a file, such as a length and creation/modification time of the file, may be acquired by using stat. In addition, the operating system also provides a fiemap interface, so that a storage location of a file in the file system can be acquired very efficiently in a user mode. Normally, although the file in step 1b is closed, metadata is still in the memory of the operating system. Therefore, querying the metadata immediately at a closing time point does not generate additional disk I/O.

### 2. Corrective Backup

A normal backup path of step 1 relies on that the backup service can sense modifications of all files and normally persist metadata of these modified files. However, in actual operations, an event monitored by inotify may be lost, and the metadata backup service may suddenly be killed or exceptionally exited at some instant, resulting in that metadata of a modified or newly created file is not normally backed up in this period. In this case, a separate corrective backup channel is needed to check for and filling omissions. A basic process is as follows:
a. An effective file list and necessary metadata, such as a file length, creation time, and an Inode number, in a current data service are acquired by using an RPC or a checkpoint file of the data service. The information stored in the checkpoint file requires relatively small storage space, and is contiguously stored in a storage medium, resulting in relatively low reading overheads. In addition, the information may also be acquired by using the RPC in a memory mode, so that no loss is caused to I/O performance of an HDD.
b. Known backup metadata in a metadata backup warehouse is read, and a known file metadata backup table is constructed.
c. Entries in step 2a and step 2b are compared. If the following conditions are all satisfied, it is considered that backed-up metadata is still valid; otherwise, omissions of the metadata backup are checked for and filled in a manner that is similar to step 1c and that may consume disk I/O: i. File names are the same; ii. Creation time is the same; iii. Inode numbers are the same; and iv. File lengths are the same.

In the foregoing metadata backup procedure, after sufficient information is acquired by using stat/fiemap, information including, but not limited to, a file name (a file path), a file length, file creation time, an Inode number, an extents list, and the like may be persisted, thereby completing the metadata backup.

By using the foregoing solution, the metadata backup may be completed in a normal path with substantially no additional HDD I/O, thereby reducing impact on a production service and improving availability of the backup service. In addition, this backup manner does not require any modifications in a storage service, and therefore has broader applicability.

The present disclosure provides a method for backing up metadata of a file on an HDD. The method provides a universal solution of backing up metadata of a file system, and is applicable to various on-cloud and off-cloud storage systems. According to the method, by using an interface of an operating system, an event of closing a file write handle in a data directory is monitored, and then a corrective solution of checking for and filling omissions is performed, to ensure as much as possible that search is performed at the timing when corresponding metadata is still in kernel memory, thereby avoiding additional disk I/O operations. In addition, all operations are performed by using a conventional interface supported by the operating system requiring no kernel adaptation, thereby greatly reducing various risks.

The present disclosure further provides a metadata backup server, including: an acquisition module, an event module, and a backup module, where the acquisition module is configured to acquire directory information of data written on an HDD by a data service; the event module is configured to monitor a written file closing event of the directory information, and acquire closed file information returned according to the written file closing event; and the backup module is configured to determine a closed file according to the closed file information, acquire metadata of the closed file, and back up the metadata to a metadata backup warehouse.

In embodiments of the present disclosure, the acquisition module is configured to acquire the directory information of the data written on the HDD by the data service; the event module is configured to monitor the written file closing event of the directory information, and acquire the closed file information returned according to the written file closing event; and the backup module is configured to determine the closed file according to the closed file information, acquire the metadata of the closed file, and back up the metadata to the metadata backup warehouse. In the embodiments of the present disclosure, the directory information of the data written on the HDD by the data service is monitored in an operating system. When it is detected that the written file closing event occurs, the closed file information returned according to the written file closing event is acquired. The closed file is determined according to the closed file information. In this way, the metadata of the closed file is acquired when the metadata is still in kernel memory as much as possible, and backup of the metadata to the metadata backup warehouse is implemented while an additional disk I/O operation is avoided.

In a possible implementation, the event module is specifically configured to monitor the written file closing event of the directory information by using an inotify component, and acquire the closed file information returned by the inotify component according to the written file closing event, where the closed file information includes a watch descriptor and a file name.

In a possible implementation, the backup module is specifically configured to generate a closed file path according to the watch descriptor and the file name; and determine the closed file according to the closed file path.

In a possible implementation, the backup module is specifically configured to acquire the metadata of the closed file by using a fiemap interface and/or a stat system call.

In a possible implementation, a correction module is further included, which is configured to acquire first metadata of a first file managed by the data service, where the first metadata includes one or more of file name data, creation instant data, Inode data, or file length data; load second metadata in the metadata backup warehouse; compare the first metadata with the second metadata, and determine incremental file list information according to a comparison result; and acquire incremental metadata according to the incremental file list information, and back up the incremental metadata.

In a possible implementation, the correction module is specifically configured to add file name data corresponding to first target metadata to the incremental file list information if the first metadata includes the first target metadata and the second metadata does not include the first target metadata; and add a file name of second target metadata in the first metadata to the incremental file list information if the second target metadata in the first metadata is different from the second target metadata in the second metadata in any one or more of file name data, creation instant data, Inode data, or file length data.

In a possible implementation, the correction module is specifically configured to acquire, by using a remote procedure call to the data service and/or loading a checkpoint file of the data service, the first metadata of the first file managed by the data service.

An embodiment of the present disclosure further includes a storage system, including the foregoing metadata backup server.

An embodiment of the present disclosure further provides an electronic device, including: at least one processor; and a storage in communication connection with the at least one processor. The storage stores a computer program that can be executed by the at least one processor, and the computer program, when executed by the at least one processor, causes the electronic device to perform the method according to the embodiments of the present disclosure.

An embodiment of the present disclosure further provides a non-transitory computer-readable storage medium storing a computer program, where the computer program, when executed by a processor of a computer, is used to cause the computer to perform the method according to the embodiments of the present disclosure.

An embodiment of the present disclosure further provides a computer program product including a computer program. The computer program, when executed by a processor of a computer, is used to cause the computer to perform the method according to the embodiments of the present disclosure.

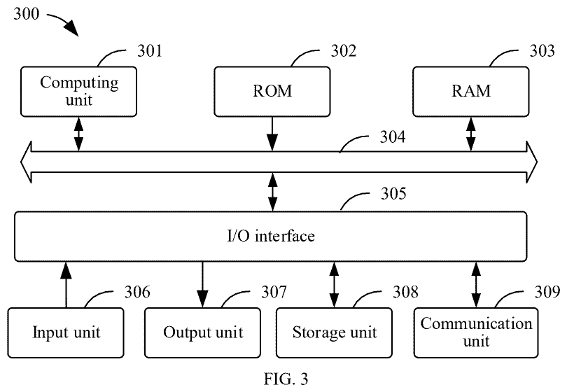

Refer to FIG. 3. a structural block diagram of an electronic device 300 that may be used as a server or a user device of the present disclosure is now described. It is an example of a hardware device that may be used in various aspects of the present disclosure. The electronic device is intended to represent various forms of digital electronic computer devices, such as a laptop computer, a desktop computer, a workbench, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in this specification, their connections and relationships, and their functions are merely used as examples, and are not intended to limit implementation of the present disclosure described and/or claimed in this specification.

As shown in FIG. 3, the electronic device 300 includes a computing unit 301, which can perform various appropriate actions and processing according to a computer program stored in a read-only memory (ROM) 302 or a computer program loaded from a storage unit 308 into a random access memory (RAM) 303. The RAM 303 can further store various programs and data needed for operating the device 300. The computing unit 301, the ROM 302, and the RAM 303 are connected to each other through a bus 304. An input/output (I/O) interface 305 is also connected to the bus 304.

A plurality of components in the electronic device 300 are connected to the I/O interface 305, including: an input unit 306, an output unit 307, the storage unit 308, and a communication unit 309. The input unit 306 may be any type of device capable of inputting information to the electronic device 300, and the input unit 306 may receive input numeric or character information and generate a key signal input related to user settings and/or function control of the electronic device. The output unit 307 may be any type of device that can present information, and may include, but is not limited to, a display, a speaker, a video/audio output terminal, a vibrator, and/or a printer. The storage unit 308 may include, but is not limited to, a disk and an optical disc. The communication unit 309 allows the electronic device 300 to exchange information/data with another device through a computer network like the Internet and/or various telecommunication networks, and may include, but is not limited to, a modem, a network adapter, an infrared communication device, a wireless communication transceiver and/or a chip set, for example, a Bluetooth device, a Wi-Fi device, a WiMax device, a cellular communication device, and/or the like.

The computing unit 301 may be various general-purpose and/or special-purpose processing components having processing and computing capabilities. Some examples of the computing unit 301 include, but are not limited to, a processing unit (CPU), a graphics processing unit (GPU), various specialized artificial intelligence (AI) computing chips, various computing units running machine learning model algorithms, a digital signal processor (DSP), and any suitable processor, controller, microcontroller, and the like. The computing unit 301 performs the methods and processing described above. For example, in some embodiments, the foregoing method may be implemented as a computer software program that is tangibly included in a machine-readable medium, for example, the storage unit 308. In some embodiments, a part or all of the computer program may be loaded and/or installed on the electronic device 300 through the ROM 302 and/or the communication unit 309. In some embodiments, the computing unit 301 may be configured to perform the foregoing method in any other suitable manner (for example, with the help of firmware).

Program code used to implement the method of the embodiments of the present disclosure may be written in any combination of one or more programming languages. The program code may be provided for a processor or a controller of a general-purpose computer, a special-purpose computer, or another programmable data processing apparatus, so that the program code, when executed by the processor or the controller, enables implementation of the functions/operations specified in the flowchart and/or the block diagram. The program code may be completely executed on a machine, partially executed on the machine, partially executed on the machine as an independent software package and partially executed on a remote machine, or completely executed on a remote machine or server.

In the context of the embodiments of the present disclosure, the machine-readable medium may be a tangible medium that may include or store a program used by an instruction execution system, apparatus, or device or used in combination with an instruction execution system, apparatus, or device. The machine-readable medium may be a machine-readable signal medium or a machine-readable storage medium. The machine-readable medium may include, but is not limited to, an electric, magnetic, optical, electromagnetic, infrared, or semiconductor system, apparatus, or device, or any suitable combination of the above. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

It should be noted that, the term “include” and variations thereof used in the embodiments of the present disclosure are open inclusions, that is, “include but are not limited to”. The term “based on” is “at least partially based on”. The term “an embodiment” represents “at least one embodiment”. The term “another embodiment” represents “at least one another embodiment”. The term “some embodiments” represents “at least some embodiments”. Modifications of “one” and “a plurality of” mentioned in the embodiments of the present disclosure are illustrative rather than restrictive, and a person skilled in the art should understand that, unless clearly indicated otherwise in the context, the modifications should be understood as “one or more”.

User information (including but not limited to user device information, user personal information, and the like) and data (including but not limited to data for analysis, data for storage, data for display, and the like) involved in the embodiments of the present disclosure are all information and data authorized by a user or fully authorized by each party, and collection, use, and processing of related data need to comply with relevant laws, regulations and standards of related countries and regions. In addition, a corresponding operation entry is provided for the user to choose authorization or rejection.

The steps set forth in the method implementations provided in the embodiments of the present disclosure may be performed in different orders and/or in parallel. In addition, the method implementations may include additional steps and/or omit execution of illustrated steps. The protection scope of the present disclosure is not limited in this aspect.

The term “embodiment” in this specification means that a specific feature, structure, or characteristic described with reference to the embodiment may be included in at least one embodiment of the present disclosure. The phrase appearing at various positions in this specification neither necessarily refers to the same embodiment, nor refers to an independent or an embodiment exclusive of other embodiments. Embodiments in this specification are described in a related manner, and the same or similar parts between the embodiments may be referred to each other. Especially, apparatus, device, and system embodiments are substantially similar to the method embodiments, and therefore are described briefly. For related parts, reference may be made to partial descriptions in the method embodiments.

The foregoing embodiments merely describe some implementations of the present disclosure and are described in detail, but cannot be accordingly construed as a limitation to the protection scope of the patent. It should be noted that for a person of ordinary skill in the art, several transformations and improvements can be made without departing from the idea of the present disclosure. These transformations and improvements all belong to the protection scope of the present disclosure. Therefore, the protection scope of the present disclosure is subject to the appended claims.

1. A method for backing up metadata of a file on an HDD, comprising:
acquiring directory information of data written on the HDD by a data service;
monitoring a written file closing event of the directory information, and acquiring closed file information returned according to the written file closing event; and
determining a closed file according to the closed file information, acquiring metadata of the closed file, and backing up the metadata to a metadata backup warehouse.

2. The method according to claim 1, wherein monitoring the written file closing event of the directory information, and acquiring the closed file information returned according to the written file closing event comprises:
monitoring the written file closing event of the directory information by using an inotify component, and acquiring the closed file information returned by the inotify component according to the written file closing event, wherein the closed file information comprises a watch descriptor and a file name.

3. The method according to claim 2, wherein determining the closed file according to the closed file information comprises:
generating a closed file path according to the watch descriptor and the file name; and
determining the closed file according to the closed file path.

4. The method according to claim 1, wherein obtaining the metadata of the closed file comprises:
acquiring the metadata of the closed file by using a fiemap interface and/or a stat system call.

5. The method according to claim 1, after backing up the metadata, further comprising:
acquiring first metadata of a first file managed by the data service, wherein the first metadata comprises one or more of file name data, creation instant data, Inode data, or file length data;
loading second metadata in the metadata backup warehouse;
comparing the first metadata with the second metadata, and determining incremental file list information according to a comparison result; and
acquiring incremental metadata according to the incremental file list information, and backing up the incremental metadata.

6. The method according to claim 5, wherein determining the incremental file list information according to the comparison result comprises:
adding file name data corresponding to first target metadata to the incremental file list information if the first metadata comprises the first target metadata, and the second metadata does not comprise the first target metadata;
adding a file name of second target metadata in the first metadata to the incremental file list information if the second target metadata in the first metadata is different from the second target metadata in the second metadata in any one or more of file name data, creation instant data, Inode data, and file length data.

7. The method according to claim 5, wherein acquiring the first metadata of the first file managed by the data service comprises:
acquiring, by using a remote procedure call to the data service and/or loading a checkpoint file of the data service, the first metadata of the first file managed by the data service.

8. A metadata backup server, wherein the metadata backup server is configured to acquire directory information of data written on the HDD by a data service;
monitor a written file closing event of the directory information, and acquire closed file information returned according to the written file closing event; and
determine a closed file according to the closed file information, acquire metadata of the closed file, and back up the metadata to a metadata backup warehouse.

9. A storage system, comprising the metadata backup server according to claim 8.

10. An electronic device, comprising:
a processor; and
a storage storing a program, wherein
the program comprises instructions, and the instructions, when executed by the processor, cause the processor to:
acquire directory information of data written on the HDD by a data service;
monitor a written file closing event of the directory information, and acquire closed file information returned according to the written file closing event; and
determine a closed file according to the closed file information, acquire metadata of the closed file, and back up the metadata to a metadata backup warehouse.

11. A non-transitory computer-readable storage medium storing computer instructions, wherein the computer instructions are used for causing a computer to perform steps of the method according to claim 1.

12. (canceled)

13. The metadata backup server according to claim 8, wherein the metadata backup serve is further configured to:
monitor the written file closing event of the directory information by using an inotify component, and acquire the closed file information returned by the inotify component according to the written file closing event, wherein the closed file information comprises a watch descriptor and a file name.

14. The metadata backup server according to claim 13, wherein the metadata backup serve is further configured to:
generate a closed file path according to the watch descriptor and the file name; and
determine the closed file according to the closed file path.

15. The metadata backup server according to claim 8, wherein the metadata backup serve is further configured to:
acquire the metadata of the closed file by using a fiemap interface and/or a stat system call.

16. The metadata backup server according to claim 8, wherein the metadata backup serve is further configured to:
acquire first metadata of a first file managed by the data service, wherein the first metadata comprises one or more of file name data, creation instant data, Inode data, or file length data;
load second metadata in the metadata backup warehouse;
compare the first metadata with the second metadata, and determine incremental file list information according to a comparison result; and
acquire incremental metadata according to the incremental file list information, and back up the incremental metadata.

17. The metadata backup server according to claim 16, wherein the metadata backup serve is further configured to:
add file name data corresponding to first target metadata to the incremental file list information if the first metadata comprises the first target metadata, and the second metadata does not comprise the first target metadata;
add a file name of second target metadata in the first metadata to the incremental file list information if the second target metadata in the first metadata is different from the second target metadata in the second metadata in any one or more of file name data, creation instant data, Inode data, and file length data.

18. The electronic device according to claim 10, wherein the program further causes the processor to:
monitor the written file closing event of the directory information by using an inotify component, and acquire the closed file information returned by the inotify component according to the written file closing event, wherein the closed file information comprises a watch descriptor and a file name.

19. The electronic device according to claim 18, wherein the program further causes the processor to:
generate a closed file path according to the watch descriptor and the file name; and
determine the closed file according to the closed file path.

20. The electronic device according to claim 10, wherein the program further causes the processor to:
acquire the metadata of the closed file by using a fiemap interface and/or a stat system call.

21. The electronic device according to claim 10, wherein the program further causes the processor to:
acquire first metadata of a first file managed by the data service, wherein the first metadata comprises one or more of file name data, creation instant data, Inode data, or file length data;
load second metadata in the metadata backup warehouse;
compare the first metadata with the second metadata, and determine incremental file list information according to a comparison result; and
acquire incremental metadata according to the incremental file list information, and back up the incremental metadata.
